(19) United States
(12) Patent Application Publication
(10) Pub. No.: US 2011/0141596 A1
(43) Pub. Date: Jun. 16, 2011

(54) HIGH REFLECTION RATIO MATERIAL

(75) Inventor: Jin Can Wang, Xinzhuang City (TW)

(73) Assignee: Shih Yu Chen, Luzhou City (TW)

(21) Appl. No.: 12/636,766

(22) Filed: Dec. 13, 2009

(51) Int. Cl. G02B 5/08

(52) U.S. Cl. 359/884

(57) ABSTRACT

A high reflection ratio material has: a surface layer having a resin layer with an adhesive; a glass bead layer disposed over the surface layer, wherein the glass bead layer having at least one glass beads disposed apart from; the primer layer disposed over the glass bead layer and used for securing the glass beads; the color layer disposed over the primer layer, and the color layer is a printed on the primer layer using a UV OFFSET printing technique; the mirror layer disposed over the color layer and capable of reflecting light to enhance the color layer; and the base disposed over the mirror layer. When a user tears off the surface layer, light shines on the glass bead layer, the light is able to pass through the gap and to sequentially shine and be reflected by the mirror layer, which can increase the brightness.

### BACKGROUND OF THE INVENTION

1. Field of the Invention

The present invention relates to a high reflection ratio material, and more particularly to a high reflection ratio material having a specific layered structure to enhance color ink.

2. Description of the Related Art

Currently, with rapid technological improvements, typical reflective stickers cannot satisfy the needs of all consumers, particularly when they want more complicated figures and colors on a reflective surface. A prior art technology utilizes a screen printing method to print the color ink on a glass bead surface.

Please refer to FIG. 1. FIG. 1 is a cross-sectional drawing of a prior art reflective material. As shown in the drawing, the reflective material has an aluminum mirror layer 11 under a glass bead layer 1, and a resin material 12 that is used for securing to a base 13. In order to provide colorful reflective effects, a typical prior art technique is to coat the surface of the glass beads of the reflective material using a screen print technique.

However, the above-mentioned prior art technology has the following drawbacks: when the color layer is coated onto the glass bead surface by way of the screen print technique, due to the relationship between fluid stresses and the uneven surface of the glass bead layer 1, the thickness of the dry color layer is hard to control and it may not attach evenly onto the glass bead layer 1 (making thinner layers on raised surfaces and thicker layers on depressions). This causes large differences in reflection, as well as uneven color coating. In addition, since the surface of the glass bead layer 1 is not smooth, the outline for figures may not print clearly, and the ink directly attaches to the glass bead surface, which leads to low abrasion resistance and low water resistance.

Therefore, it is desirable to provide a high reflection ratio material to mitigate and/or obviate the aforementioned problems.

### SUMMARY OF THE INVENTION

An objective of the present invention is to provide a high reflection ratio material, which utilizes a unique multiple layer structure to provide higher brightness, colorful figures, and a shorter printing time.

In order to achieve the above-mentioned objectives, a high reflection ratio material has: a surface layer having a resin layer with an adhesive; a glass bead layer disposed over the surface layer, wherein the glass bead layer comprises glass beads spaced apart from each other; a primer layer disposed over the glass bead layer and used for securing the glass beads; a color layer disposed over the primer layer, in which the color layer is a printed on the primer layer using a UV OFFSET printing technique; a mirror layer disposed over the color layer and capable of reflecting light to enhance the color layer; and a base disposed over the mirror layer. The glass bead layer may be sprayed or spread onto the surface layer, and during application of the glass bead layer, as shown, the glass beads sink into the resin layer and in the embedded portions of the glass beads are about half the volume of the glass beads, which can maximize the brilliance of the glass beads. The mirror layer is capable of reflecting light to enhance the color layer; the light passes through the gap to sequentially shine on the primer layer and the color layer, and is then reflected by the mirror layer. The present invention overcomes the above-mentioned drawbacks of the prior art, and also provides higher brightness, colorful figures, and a shorter printing time.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional drawing of a prior art reflective material.

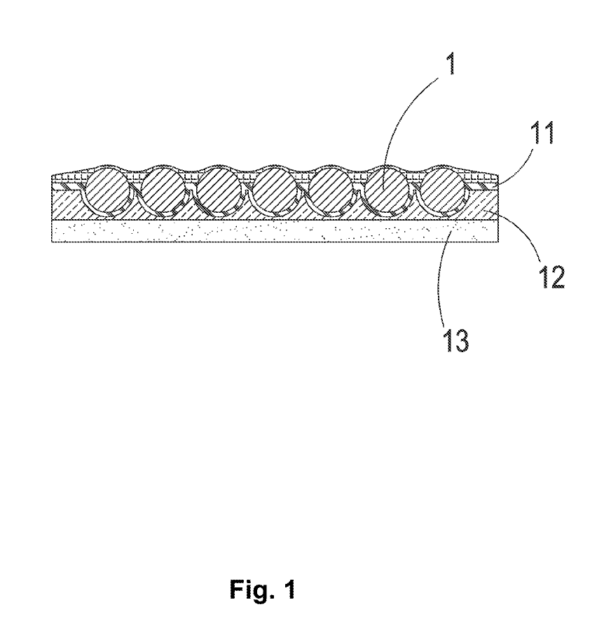

FIG. 2 is a first cross-sectional drawing of a preferred embodiment according to the present invention.

FIG. 3 is a second cross-sectional drawing of a preferred embodiment according to the present invention.

FIG. 4 is a first schematic drawing of a preferred embodiment according to the present invention.

FIG. 5 is a second schematic drawing of a preferred embodiment according to the present invention.

FIG. 6 is a third schematic drawing of a preferred embodiment according to the present invention.

### DETAILED DESCRIPTION OF THE PREFERRED EMBODIMENT

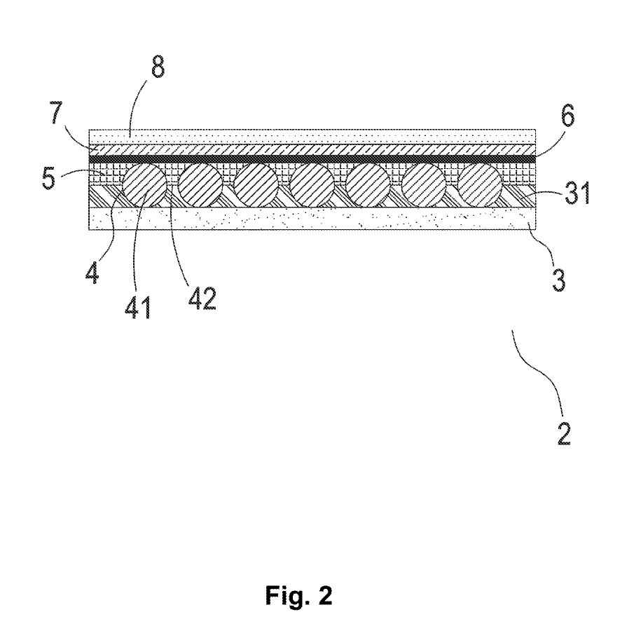

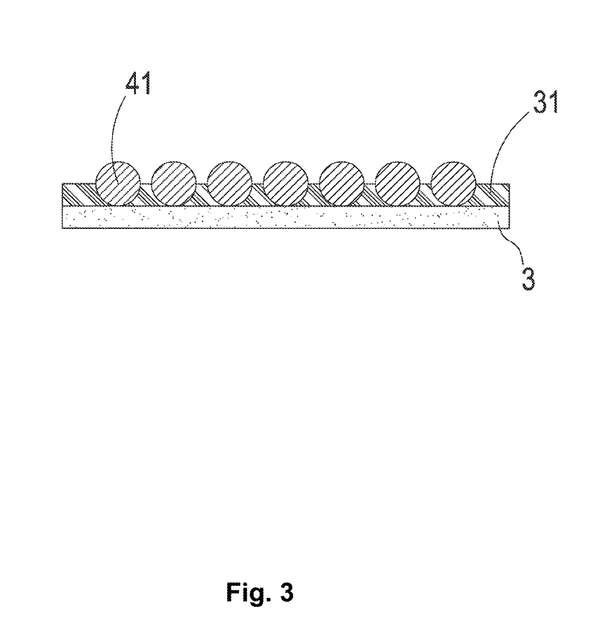

Please refer to FIG. 2 and FIG. 3. FIG. 2 is a first cross-sectional drawing of a preferred embodiment according to the present invention. FIG. 3 is a second cross-sectional drawing of a preferred embodiment according to the present invention. As shown in the drawings, a high reflection ratio material 2 comprises a surface layer 3, a glass bead layer 4, a primer layer 5, a color layer 6, a mirror layer 7, and a base 8. The surface layer 3 is the top surfaced and is comprises polyethylene terephthalate (PET). The surface layer 3 includes a resin layer 31 having an adhesive, and the resin layer 31 is made of a PE modified gel. The glass bead layer 4 is disposed over the surface layer 3, wherein the glass bead layer 4 comprises at least two glass beads 41 and a gap 42 is disposed between the glass beads 41. The glass bead layer 4 is sprayed or spread onto the surface layer 3. The primer layer 5 is disposed over the glass bead layer 4 and used for securing the glass beads 41 so the glass beads 41 are more stable and more tighten together. The primer layer 5 is a special primer. The color layer 6 is disposed over the primer layer 5, the color layer 6 has full colors, and the color layer 6 is a printed on the primer layer 5 using a UV OFFSET printing technique. The mirror layer 7 is disposed over the color layer 6 and capable of reflecting light to enhance the color layer 6, and the mirror layer 7 is capable of reflecting light to make the color layer 6 more colorful. The mirror layer 7 is one of an electrically plated material, a mirror or a reflective material. The base 8 is disposed over the mirror layer 7, and the base 8 comprises at least one of a hot melt glue or an edge jointing adhesive.

In addition, when the manufacturer spray or spread the glass beads 41 over the resin layer 31 of the surface layer 3, the manufacturer can also squeeze, press or heat a half size of the glass beads 41 into the surface layer 3 so the glass bead 41 can be more glossy.

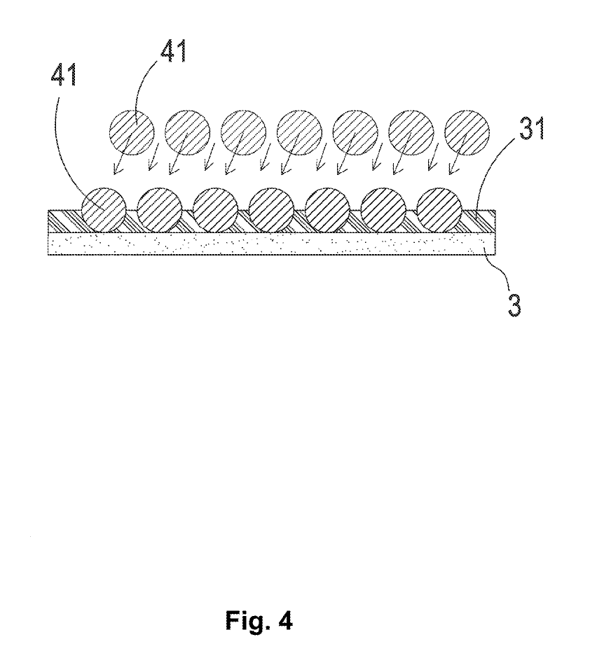

Please refer to FIG. 4. FIG. 4 is a first schematic drawing of a preferred embodiment according to the present invention. As shown in FIG. 4, the surface layer 3 has the resin layer 31 having an adhesive, at least one glass bead 41 is placed on the resin layer 31, and the glass bead 41 is sprayed or spread onto the surface layer 3. Furthermore, during the glass bead 41 application, as shown, the glass bead 41 sinks into the resin layer 31 and a sunk-in portion of the glass bead 41 is half volume of the glass bead 41, which can make the glass bead 41 has a maximum brightness.

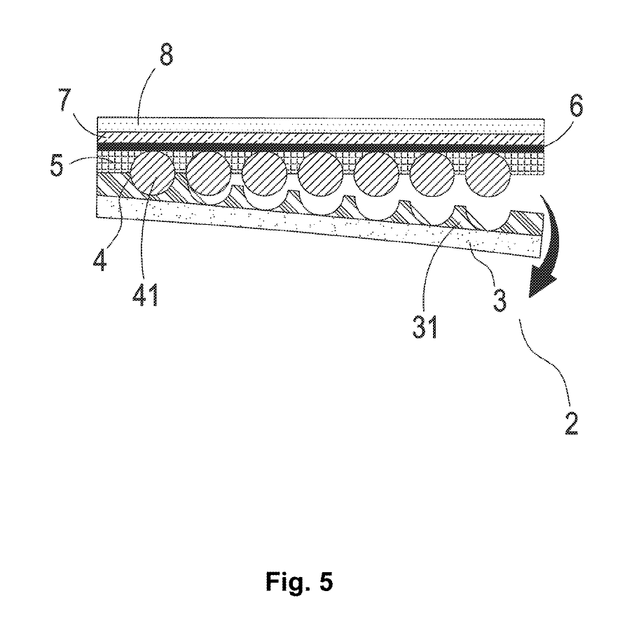

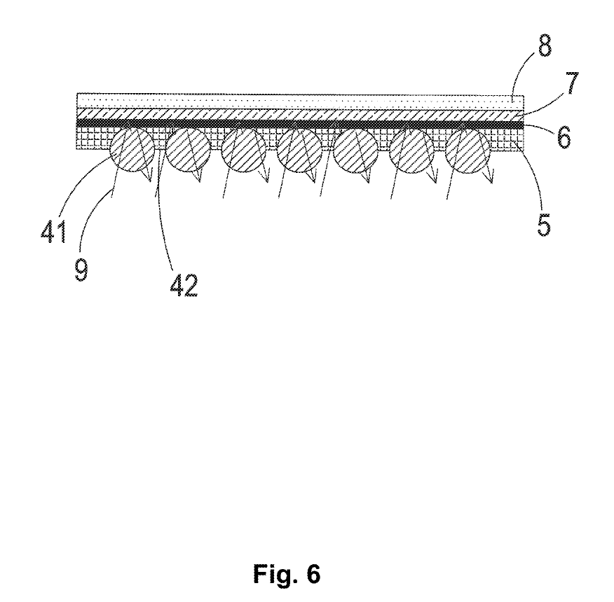

Please refer to FIG. 5 and FIG. 6. FIG. 5 is a second schematic drawing of a preferred embodiment according to the present invention. FIG. 6 is a third schematic drawing of a preferred embodiment according to the present invention. As shown in the drawings, in the high reflection ratio material 2, the surface layer 3 has the resin layer 31 with an adhesive; the glass bead layer 4 is disposed over the surface layer 3, wherein the glass bead layer 4 comprises at least one glass beads 41 disposed apart from; the primer layer 5 is disposed over the glass bead layer 4 and used for securing the glass beads 41; the color layer 6 is disposed over the primer layer 5, and the color layer 6 is a printed on the primer layer 5 using a UV OFFSET printing technique; the mirror layer 7 is disposed over the color layer 6 and capable of reflecting light to enhance the color layer 6; and the base 8 is disposed over the mirror layer 7. When a user wants to use the high reflection ratio material 2, the user can tear off the surface layer 3 (that will also tear off the resin layer 31 together), so the glass bead layer 4 is exposed. When light 9 shines on the glass bead layer 4, due to the gap 42 around the glass bead 41, the light 9 is able to pass through the gap 42 and to sequentially shine on the primer layer 5 and the color layer 6, then to be reflected by the mirror layer 7 and pass through the glass bead 41 to shine the glass bead 41 again, which can increase the brightness more than 200 cd/m2.

Comparing with the prior art technology, the present invention has following benefits:

1. The color layer 6 of the present invention is printed using a UV OFFSET printing technique, not the traditional screen print technique.

2. The color layer 6 is colorful, which is much reflective than the traditional black and white presentation.

3. The primer layer 5 is used for securing the glass bead 41 such that the glass bead 41 can be tightly attached.

The color layer 6 is directly printed on the primer layer 5, the color layer 6 is covered by the mirror layer 7, so when the light 9 is illuminating the color layer 6 is more glossy, and with the enhancement provided by the glass bead 41, the brightness is increased more than 200 cd/m2.

Although the present invention has been explained in relation to its preferred embodiment, it is to be understood that many other possible modifications and variations can be made without departing from the spirit and scope of the invention as hereinafter claimed.

What is claimed is:

1. A high reflection ratio material comprising:
a surface layer;
a glass bead layer disposed over the surface layer, wherein the glass bead layer comprises a plurality of glass beads separated from each other and disposed partially in the surface layer;
a primer layer disposed over the glass bead layer and used for securing the glass beads, wherein the glass beads protrude from the primer layer;
a color layer disposed over the primer layer;
a mirror layer disposed over the color layer and capable of reflecting light to enhance the color layer; and
a base disposed over the mirror layer;
wherein the surface layer is removable from the glass bead layer to expose the glass bead over the primer layer.

2. The high reflection ratio material as claimed in claim 1, wherein the surface layer is comprises polyethylene terephthalate (PET).

3. The high reflection ratio material as claimed in claim 1, wherein the surface layer includes a resin layer having an adhesive.

4. The high reflection ratio material as claimed in claim 3, wherein the resin layer is made of a PE modified gel.

5. The high reflection ratio material as claimed in claim 1, wherein the glass bead layer is sprayable or speadable onto the surface layer.

6. (canceled)

7. The high reflection ratio material as claimed in claim 1, wherein the color layer is printed using a UV OFFSET printing technique.

8. The high reflection ratio material as claimed in claim 1, wherein the mirror layer is one of an electrically plated material, a mirror or a reflective material.

9. The high reflection ratio material as claimed in claim 1, wherein the base comprises at least one of a hot melt glue or an edge-jointing adhesive.
